(19) United States
(12) Patent Application Publication
(10) Pub. No.: US 2023/0265711 A1
(43) Pub. Date: Aug. 24, 2023

(54) DEVICE FOR PREVENTION OF DEBRIS AND/OR PEST INFILTRATION INTO A STRUCTURAL SPACE

(71) Applicant: Tony Cooper, Bella Vista, AR (US)

(72) Inventor: Tony Cooper, Bella Vista, AR (US)

(21) Appl. No.: 18/172,620

(22) Filed: Feb. 22, 2023

Related U.S. Application Data
(60) Provisional application No. 63/268,324, filed on Feb. 22, 2022.

(51) Int. Cl. E06B 9/00

(52) U.S. Cl. CPC E06B 9/00; E06B 2009/002

(57) ABSTRACT

A pest/debris infiltration prevention device in the form of a netting barrier that spans a passageway at the floor level. The netting barrier assembly is mounted to the supportive framing of the passageway by opposing tensioning mechanisms that provide tension along the netting barrier. The different engagements of the upper and lower portions of the netting barrier to the tension mechanisms enables the netting barrier to be biased in an upright position and pivot about the floor level to a prone position when stepped on, run over by a wheel or otherwise top loaded, and spring back upright when unloaded. The present invention permits vehicles or other objects to pass in and out of the passageway whilst still performing its core function of preventing ingress of unwanted elements.

### CROSS-REFERENCE TO RELATED APPLICATION

This application claims the benefit of priority of U.S. provisional application No. 63/268,324 filed Feb. 22, 2022, the contents of which are herein incorporated by reference.

### BACKGROUND OF THE INVENTION

The present invention relates to systems, devices, and methods for preventing infiltration of various elements into a structural space and more particularly, to a mesh/netting barrier assembly that prevents debris and/or pests from entering a structural space.

Currently, leaves, debris and pests can infiltrate a structural space through an open doorway or other passageway. Prior art solutions cover the entire entrance, making the entrance unusable for entrance and egress.

A need exists for a mesh/netting assembly that prevents debris and/or pests from entering a structural space through a passageway, while still permitting the flow of (foot and vehicular) traffic therethrough. The mesh/netting assembly is dimensioned and adapted to pivot from an upright position to a flat position when trampled, yet spring back to the upright position after the traffic has passed.

### SUMMARY OF THE INVENTION

In one aspect of the present invention, a debris barrier for a passageway includes the following: a netting extending between two tension mechanisms; each tension mechanism mounted to a vertical framing of the passageway, wherein an elastic cord interconnects an upper portion of a longitudinal end of the netting to the tension mechanism, and wherein a webbing interconnects a lower portion of the longitudinal end of the netting to the tension mechanism; the elastic cord selectively provides tension to the netting; and the webbing is configured so that the netting moves to a sideways condition when top loaded and returns to an upright condition when unloaded.

In another aspect of the present invention, the debris barrier for the passageway further includes: one or more mounting brackets operatively associated with each tension mechanism for selectively mounting the tension mechanism to the vertical framing, wherein each tension mechanism defines a housing having a plurality of cord brackets for tensioning the elastic cord through redirection; further including for each tension mechanism a webbing rod vertically oriented in the housing, wherein the webbing rod engages the webbing, wherein the webbing ends in an eyelet for receiving the webbing rod, wherein the webbing rod is removable for connecting or disconnecting the webbing, wherein the engagement of the eyelet and the webbing rod secures the webbing in a vertical orientation, wherein a longitudinal length of the webbing is at least ten times its latitudinal width oriented horizontally, wherein the one or more cord brackets comprises at least two cord brackets that redirect the elastic cord from a lateral orientation to a vertical orientation and to a transvers orientation, wherein the housing defines a L-shape, and wherein the netting has a vertical elevation of between two and eighteen inches

These and other features, aspects and advantages of the present invention will become better understood with reference to the following drawings, description, and claims.

### BRIEF DESCRIPTION OF THE DRAWINGS

FIG. 1 is a front perspective view of an exemplary embodiment of the present invention, shown in use.

FIG. 2 is an enlarged front perspective view of an exemplary embodiment of the present invention.

FIG. 3 is a detailed perspective view of an exemplary embodiment of the present invention, indicated by line 3-3 of FIG. 1.

FIG. 4 is a cross-sectional view of an exemplary embodiment of the present invention, taken line 4-4 of FIG. 3.

FIG. 5 is an enlarged detailed perspective view of FIG. 3, with the main body cover 16A of the tensioning mechanism 50 shown in dashed lines for clarity.

FIG. 6 is an exploded perspective view of FIG. 5.

FIG. 7 is a perspective view of an exemplary embodiment of the present invention.

### DETAILED DESCRIPTION OF THE INVENTION

The following detailed description is of the best currently contemplated modes of carrying out exemplary embodiments of the invention. The description is not to be taken in a limiting sense but is made merely for the purpose of illustrating the general principles of the invention, since the scope of the invention is best defined by the appended claims.

Broadly, an embodiment of the present invention provides a pest/debris infiltration prevention device in the form of a netting barrier. Embodiments of the present invention include a net/mesh barrier that spans a passageway at the floor level. The present invention permits vehicles or other objects to pass in and out of the passageway whilst still performing its core function of preventing ingress of unwanted elements. The netting barrier assembly is mounted to the supportive framing of the passageway by opposing tensioning mechanisms that provide tension along the netting barrier. The different engagements of the upper and lower portions of the netting barrier to the tension mechanisms enables the netting barrier to pivot or fold over ninety degrees into a flat position parallel with the floor level when stepped on or run over by wheels, and spring back to its biased upright position when no longer loaded.

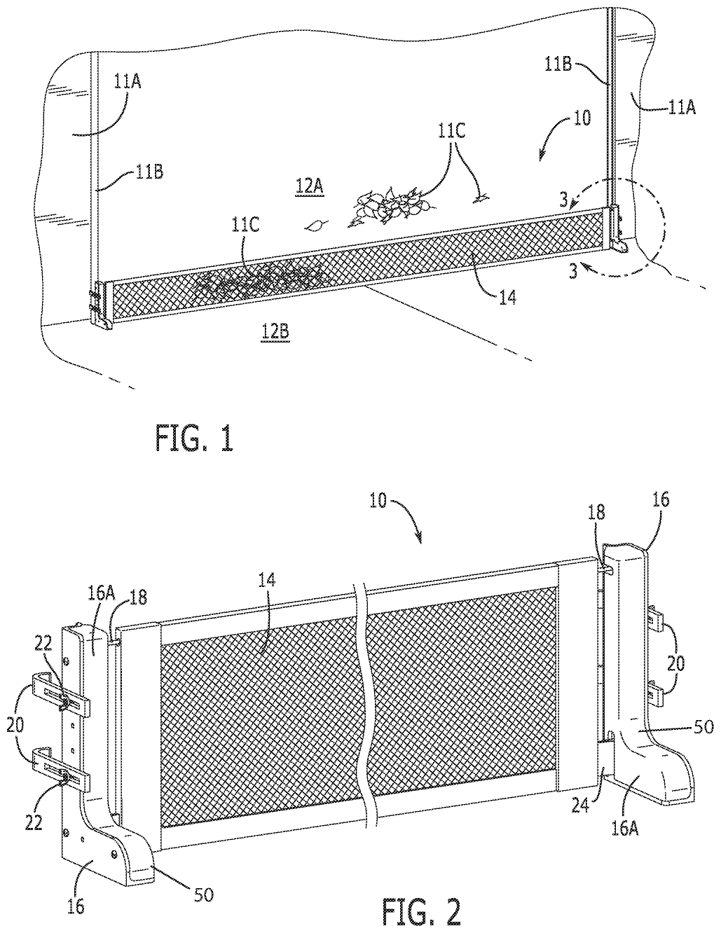

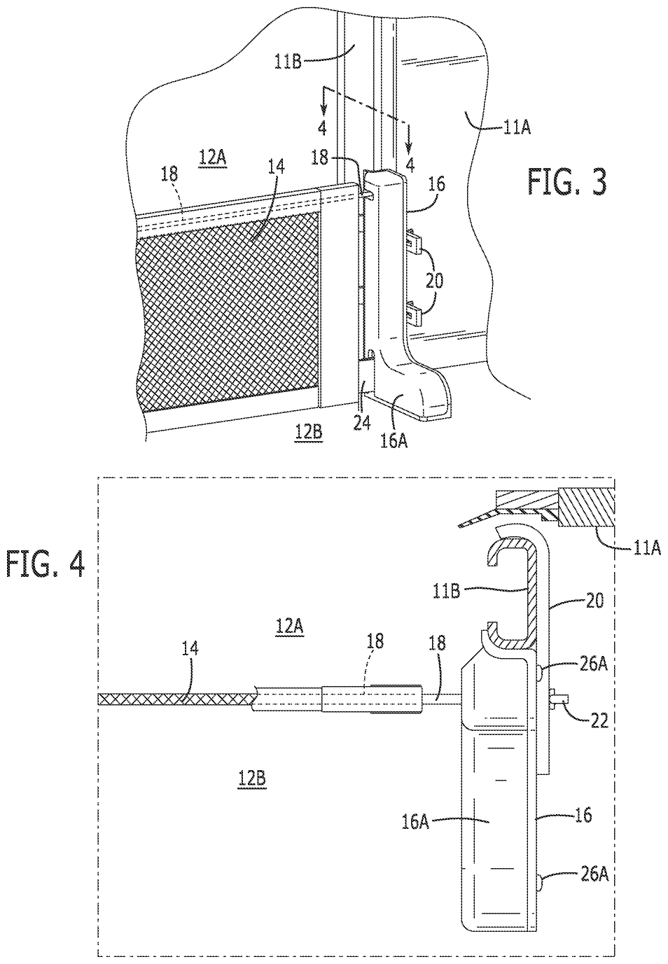

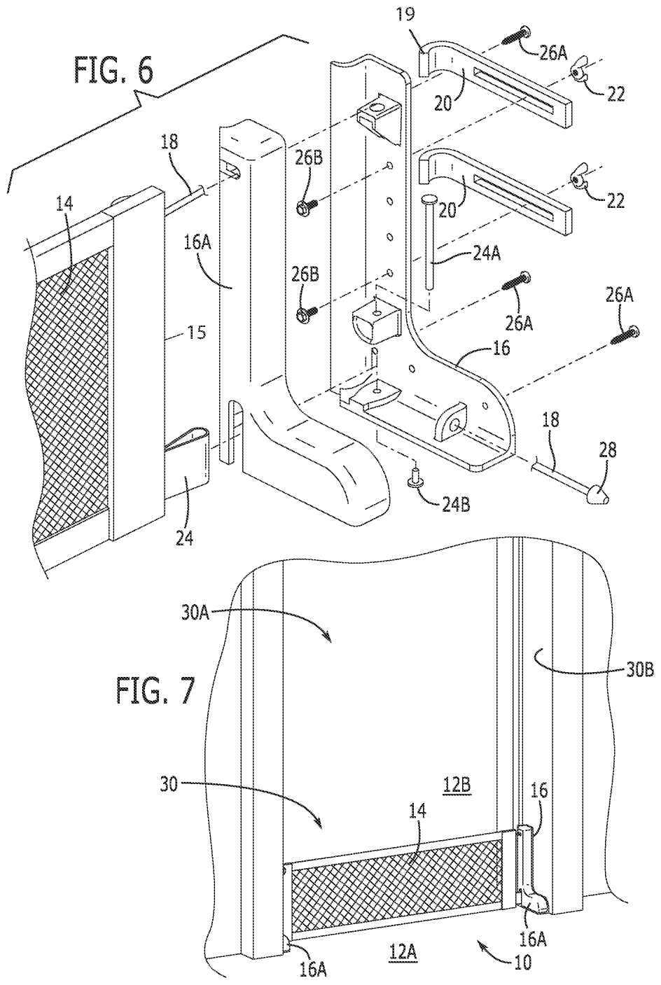

Referring now to FIGS. 1-7, a debris barrier assembly 10 or 30 for a passageway 30A is provided. The debris barrier assembly 10/30 extends, floor level, between the framing of the passageway 30A, thereby preventing debris 11C from migrating from a first space to a second space interconnected by the passageway 30A. Typically, the first space is an exterior environment where debris 11C gathers on the ground 12A, and the second space is an indoor room of a structure having an floor 12B a user wants to prevent the debris 11C from migrating to.

The barrier assembly 10 may provide a netting 14 that extends along or adjacent to floor for substantially an entirety of the width of the passageway 30A. The netting 14 has an upper elevation between two and eighteen inches off the floor, thereby enabling people to either step over or on the netting 14 when they utilize passageway 30A for its designed purpose. The netting 14 is adapted to pivot or fold over to a flat position parallel with the floor/ground when stepped on or rolled over, e.g., by the wheel of a vehicle, and then spring back to an upright orientation/position it is biased in.

The passageway 30A is typically defined by vertical framing 11B and/or a wall 11A. The vertical framing 11B may be a door jamb 30B in some embodiments, overhead door tracks in other embodiments, or any other suitable vertical framing.

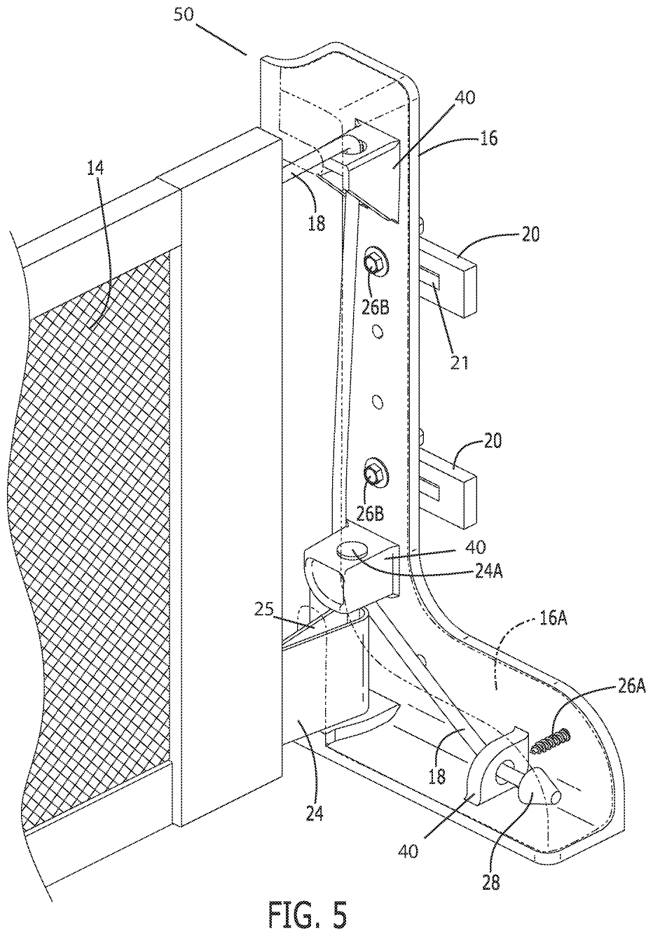

A webbing 24 may laterally extend from each longitudinal end 15 of the netting 14 so that the webbing 24 extends parallel to and may be colinear/coplanar with the netting 14, as illustrated in FIG. 5. The webbing 24 may be made from, for example, a synthetic fiber and cut to a predetermined size (e.g., length and width), and may be sewn or otherwise coupled to the longitudinal end 15 so as to form an eyelet 25.

An elastic cord 18 may also laterally extend from each longitudinal end 15 of the netting 14 so that the elastic cord 18 extends parallel to and may be colinear/coplanar with the netting 14, as illustrated in FIG. 5. The elastic cord 18 be a bungee cord or the like. The elastic cord 18 may extend from an upper portion of the longitudinal end 15, while the webbing 24, spaced there apart, may extend from a lower portion of the longitudinal end 15. The webbing 24 enables the pivotability of the netting 14 between an unloaded upright/vertical position to a loaded/horizontal position.

A tensioning mechanism 50 may be provided at each longitudinal end 15 of the netting 14. The tensioning mechanism 50 may have an L-shaped body 16. The L-shaped body 16 may have a planar vertical leg portion providing mounting holes for transversely mounting, by way of mounting fasteners 26B, one or more adjustable mounting brackets 20 to an outer surface of the vertical leg portion. Each mounting bracket 20 may have a terminal hook portion 19 and a circumscribed body slot 21. The slot 21 may be selectively engaged by way of the mounting fasteners 26B and wing nuts 22 (or equivalent fasteners) to locate and secure the hook portion 19 a desired distance from an edge of the vertical leg portion, whereby the hook portion 19 can secure the tensioning mechanism 50 to the vertical framing of the passageway 30A.

A body cover 16A may be dimensioned and adapted to engage the body 16 so as to define an L-shaped housing. The body cover 16A may be secured to the body 16 by way of mounting fasteners 26A. An interior surface of the body 16 may provide spaced apart cord brackets 40. The cord brackets 40 may each engage or stabilize the elastic cord 18 as it extends laterally from the longitudinal end 15 of the netting 14. For instance, a cord bracket 40 may provide a hole through which the elastic cord 18 passes. Or a cord bracket 40 provides a structure against which the elastic cord 18 can be redirected. As shown in FIG. 5, the uppermost cord bracket has a hole that receive the elastic cord 18, redirecting the elastic cord 18 from a lateral orientation to a vertical orientation, and then an intermediate cord bracket 40 is used to redirect the elastic cord 18 from the vertical orientation to a transverse orientation (relative to the lateral and vertical orientations) along the horizontal portion of the L-shaped housing. A final cord bracket 14 may secure the distal end of the elastic cord 18 by way of a stop 28 (such as a knot in the elastic cord 18).

A webbing rod 24A may be vertically oriented within the L-shaped housing. In certain embodiments, the webbing rod 24A may slide through a hole in the intermediate cord bracket, as illustrated in FIG. 5. The eyelet 25 of the webbing 24 may be secured to the webbing rod 24A. Due to the bendable nature of the webbing 24 and its elongated cross section (whereby its smaller cross-sectional width, relative to its cross-sectional height, is what resists the bending, pivoting, or folding over), the webbing 24 may fold over to the prone position under foot or under the weight of a wheel. The webbing 24 is biased to return to the upright position shown in the drawings. Further, rare earth magnets, hook-and-loop fasteners (not shown), and support ribs (made from, for example, plastic or metal) may be attached along the webbing 24.

Both tensioning mechanisms 50 mount, by way of the adjustable mounting brackets 20, to the vertical framing 11B and/or the associated wall 11A defining the passageway 30A. The webbing rod 24A and the cord brackets 40 provide tension (to the lower and upper portions, respectively) of the netting 14 so that the netting 14 is taut as it extends along the floor between the vertical framing 11B of the passageway 30A.

In use, the tension mechanisms 50 are mounted on the wall 11A or garage track 11B at floor level of the passageway 30A (e.g., a door or garage opening). It may be positioned such that it does not interfere with regular operation of the door. The netting 14 is connected to one tension mechanism 50 and stretched by way of the webbing rod 24A and by pulling the elastic cord 18 taut and securing or engaging it to one or more cord brackets 40. The other end of the netting 14 is then connected to the other tension mechanism 50 at the other end of the opening. Once secured in place, the device will be fully operational and prevent debris, such as leaves and pests, from entering the location/opening (when the door is open) because it extends across the floor of the opening.

See, for example, FIG. 1, which shows the device installed across a garage opening. When a vehicle or person needs to pass over it, the netting 14 can rotate to the prone positions or otherwise be deflected downwardly to allow passage of the vehicle/person past it. When a vehicle or person passes over the netting 14 the elastic cord 18 may act as an elastic/spring allows for the upper portion of the netting 14 to rotate in the direction of travel—and biasing the upper portion of the netting 14 to its upright position—whilst the bottom of the netting 14 remains in position and acts as a hinge by way of the webbing 24 engaging the vertically oriented webbing rod 24A. Under the weight of wheels or feet of the said vehicle or person, the netting 14 then flattens to the floor allowing passage into the space. Once the vehicle or person has passed over the net/mesh the elastic/spring acts on the netting 14 (by means of the force built by the weight passing over it) to pull it back to its original position. As would be readily apparent to those with skill in the art, operation is multidirectional and operates when entering or exiting the space.

In an exemplary embodiment, the pest/debris infiltration prevention device may be made or fabricated as follows. the mesh/net may be made by using industrial sewing machines and techniques. The bracket/hinge may be made using metal fabrication equipment. Additional magnets and hook and loop fasteners could be added to improve the function.

As used in this application, the term “about” or “approximately” refers to a range of values within plus or minus 10% of the specified number. And the term “substantially” refers to up to 80% or more of an entirety. Recitation of ranges of values herein are not intended to be limiting, referring instead individually to any and all values falling within the range, unless otherwise indicated, and each separate value within such a range is incorporated into the specification as if it were individually recited herein.

For purposes of this disclosure, the term “aligned” means parallel, substantially parallel, or forming an angle of less than 35.0 degrees. For purposes of this disclosure, the term “transverse” means perpendicular, substantially perpendicular, or forming an angle between 55.0 and 125.0 degrees. Also, for purposes of this disclosure, the term “length” means the longest dimension of an object. Also, for purposes of this disclosure, the term “width” means the dimension of an object from side to side. For the purposes of this disclosure, the term “above” generally means superjacent, substantially superjacent, or higher than another object although not directly overlying the object. Further, for purposes of this disclosure, the term “mechanical communication” generally refers to components being in direct physical contact with each other or being in indirect physical contact with each other where movement of one component affect the position of the other.

The use of any and all examples, or exemplary language (“e.g.,” “such as,” or the like) provided herein, is intended merely to better illuminate the embodiments and does not pose a limitation on the scope of the embodiments or the claims. No language in the specification should be construed as indicating any unclaimed element as essential to the practice of the disclosed embodiments.

In the following description, it is understood that terms such as “first,” “second,” “top,” “bottom,” “up,” “down,” and the like, are words of convenience and are not to be construed as limiting terms unless specifically stated to the contrary.

It should be understood, of course, that the foregoing relates to exemplary embodiments of the invention and that modifications may be made without departing from the spirit and scope of the present invention.

What is claimed is:

1. A debris barrier for a passageway comprising:
a netting extending between two tension mechanisms;
each tension mechanism mounted to a vertical framing of the passageway, wherein an elastic cord interconnects an upper portion of a longitudinal end of the netting to the tension mechanism, and wherein a webbing interconnects a lower portion of the longitudinal end of the netting to the tension mechanism;
the elastic cord selectively provides tension to the netting so as to bias the netting in an upright position; and
the webbing interconnection is configured as a pivot point so that the netting moves to a prone position when top loaded and returns to the upright condition when unloaded.

2. The debris barrier for the passageway of claim 1, further comprising:
one or more mounting brackets operatively associated with each tension mechanism for selectively mounting the tension mechanism to the vertical framing.

3. The debris barrier for the passageway of claim 2, wherein each tension mechanism defines a housing having a plurality of cord brackets for tensioning the elastic cord through redirection.

4. The debris barrier for the passageway of claim 3, further comprising for each tension mechanism a webbing rod vertically oriented in the housing, wherein the webbing rod engages the webbing.

5. The debris barrier for the passageway of claim 4, wherein the webbing ends in an eyelet for receiving the webbing rod.

6. The debris barrier for the passageway of claim 5, wherein the webbing rod is removable for connecting or disconnecting the webbing.

7. The debris barrier for the passageway of claim 6, wherein the engagement of the eyelet and the webbing rod secures the webbing in a vertical orientation, wherein a longitudinal length of the webbing is at least ten times its latitudinal width oriented horizontally.

8. The debris barrier for the passageway of claim 7, wherein the one or more cord brackets comprises at least two cord brackets that redirect the elastic cord from a lateral orientation to a vertical orientation and to a transvers orientation.

9. The debris barrier for the passageway of claim 8, wherein the housing defines a L-shape.

10. The debris barrier for the passageway of claim 9, wherein the netting has a vertical elevation of between two and eighteen inches.
